(19) United States
(12) Patent Application Publication
(10) Pub. No.: US 2009/0174682 A1
(43) Pub. Date: Jul. 9, 2009

(54) Instrumentation Module For A Vehicle

(75) Inventors: Upton Beall Bowden, Canton, MI (US); Eric Marshall Knight, Dearborn, MI (US); T. C. Wingrove, Canton, MI (US); Henry Lee Pope, Redford, MI (US); Yao H. Kuo, West Bloomfield, MI (US); Xiaopei Huang, Novi, MI (US); Robert Kelly Cadena, Dearborn, MI (US); James Joseph Kornacki, Dearborn, MI (US); Rongguang Zhang, Windsor (CA)

Correspondence Address: DICKINSON WRIGHT PLLC, 1875 Eye Street, NW, Suite 1200, WASHINGTON, DC, 20006, US

(73) Assignee: Visteon Global Technologies, Inc., Van Buren Township, MI (US)

(21) Appl. No.: 12/333,166

(22) Filed: Dec. 11, 2008

Related U.S. Application Data
(60) Provisional application No. 61/019,253, filed on Jan. 5, 2008.

(51) Int. Cl. G06F 3/041; B60Q 1/00

(52) U.S. Cl. 345/173; 340/462

(57) ABSTRACT

An instrumentation assembly for installation in a vehicle dashboard is disclosed herein. The instrumentation assembly includes an electronic controller, an enclosure, a viewable gauge, a viewable display, and a proximity-sensing switch. The controller has a memory for storing information. The enclosure has a designated front section and a designated rear section, wherein the front section includes substantially transparent material so as to define a window. Both the gauge and the display are electrically connected to the controller and mounted within the enclosure so as to substantially face the window. The switch is electrically connected to the controller and operable to sense the proximal presence of a human finger. In this configuration, the display is operable to exhibit the memory's information for viewing, and the switch is activatable by a human finger to selectively control the exhibition of the information on the display. Furthermore, an instrumentation module is also disclosed herein.

### CROSS REFERENCE TO A RELATED APPLICATION

The present invention claims priority from U.S. Provisional Patent Application Ser. No. 61/019,253, which was filed on Jan. 5, 2008 and also entitled “An Instrumentation Module for a Vehicle.”

### FIELD OF THE INVENTION

The present invention generally relates to automotive vehicles. The present invention more particularly relates to gauge clusters, instrument panels, audio systems, and climate control systems aboard such vehicles.

### BACKGROUND OF THE INVENTION

Observable gauge clusters that are located within the instrument panels or dashboards of automotive vehicles typically support a range of various functions. Some of these functions may include, for example, providing vehicle odometer (i.e., mileage) information and also providing vehicle trip mileage information. Typically, a vehicle driver's use of these functions is controlled via a single pushbutton (PB) switch that protrudes outward from an instrument panel's circuit board, out through a viewable appliqué, and ultimately out through a transparent lens (i.e., viewing window) of the instrument panel's gauge cluster. The hole that is defined through the gauge cluster's lens for accommodating the protruding pushbutton, however, often undesirably facilitates the introduction of dust and dirt into the instrument panel's enclosure. As a result, over time, dust and dirt can undesirably accumulate on the viewable appliqué in one or more of the panel's gauges and never be cleaned away. Consequently, the instrument panel and its gauges may begin to appear dirty and unattractive.

A pushbutton can also be awkward to reach and manipulate by a driver during vehicle operation, for the pushbutton is typically situated somewhat behind the steering wheel (i.e., handwheel) of a conventional vehicle. Furthermore, such a protruding pushbutton often adversely impacts instrument panel styling in an automotive vehicle.

In view of the above, there is a present need in the art for an automotive instrument panel assembly that eliminates protruding pushbuttons from gauge clusters while also retaining similar pushbutton control and functionality. In this way, therefore, mechanical penetration through an instrument panel's window or a gauge cluster's lens will largely be obviated.

### SUMMARY OF THE INVENTION

The present invention provides an instrumentation assembly for installation in the dashboard area of a vehicle. In one embodiment, the instrumentation assembly includes an electronic controller, an enclosure, a viewable gauge, a viewable display, and a proximity-sensing switch. The controller has a memory for storing information. The enclosure has a designated front section and a designated rear section, wherein the front section includes substantially transparent material so as to define a window. Both the gauge and the display are electrically connected to the controller and mounted within the enclosure so as to substantially face the window. The switch is electrically connected to the controller and operable to sense the proximal presence of a mass, such as a human finger. In this configuration, the display is operable to exhibit the memory's information for viewing, and the switch is activatable by a human finger to selectively control the exhibition of the information on the display.

In general, the proximity-sensing switch itself may be situated in various locations about the instrumentation assembly's enclosure. For example, the switch may be situated within the enclosure and just behind the enclosure's thin window, or the switch may alternatively be situated just underneath a thin, outer skin layer of the dashboard. In this way, therefore, the switch can be activated without requiring mechanical penetration through the enclosure's window.

Moreover, in addition to the above, the present invention also provides an instrumentation module for installation in the dashboard area of a vehicle. In one embodiment, the instrumentation module includes an enclosure, an electronic controller, a viewable display, a driver information center (DIC), an audio system, a climate control system, and a plurality of switches. The enclosure has a designated front section and a designated rear section, wherein the rear section has an electrical connector. The electronic controller is mounted within the enclosure and is electrically connected to the connector. The controller also has one or more types of memory for therein storing information. The display is mounted in the front section of the enclosure and is electrically connected to the controller. The driver information center is mounted in the enclosure and is electrically connected to one or more of the connector, the controller, and the display. Both the audio system and the climate control system are mounted within the enclosure and are each electrically connected to one or more of the connector, the controller, the display, and the driver information center. The switches are mounted in the front section of the enclosure and are electrically connected to one or more of the controller, the display, the driver information center, the audio system, and the climate control system. In this configuration, the switches are activatable by human fingers for thereby selectively controlling the display, the driver information center, the audio system, and the climate control system.

In general, the instrumentation module is more unitary and modular than conventional instrumentation assemblies and is thus more easily installable in a vehicle. In addition, when the instrumentation module is installed aboard a vehicle, the module renders the instrument panel or dashboard area of the vehicle more highly integrated. As a result, driver-to-panel interaction is improved, panel space is conserved, panel complexity is minimized, and panel cost is reduced.

Furthermore, it is believed that various alternative embodiments of the present invention will become apparent to those skilled in the art when the detailed description of the best mode(s) contemplated for practicing the invention, as set forth hereinbelow, is reviewed in conjunction with the appended claims and the accompanying drawing figures.

### BRIEF DESCRIPTION OF THE DRAWINGS

The present invention is described hereinbelow, by way of example, with reference to the following drawing figures.

FIG. 1 illustrates a frontal view of a conventional gauge cluster that is commonly present within the instrument panel of a modern automotive vehicle.

FIG. 2 illustrates a frontal view of an embodiment of an instrumentation assembly according to the present invention.

FIG. 3 illustrates a block diagram of an automotive vehicle system that includes the instrumentation assembly depicted in FIG. 2.

FIG. 4A illustrates a frontal view of a first embodiment of an instrumentation module according to the present invention.

FIG. 4B illustrates a sectional side view of the instrumentation module depicted in FIG. 4A.

FIG. 5 illustrates a block diagram of an automotive vehicle system that includes the instrumentation module depicted in FIGS. 4A and 4B.

FIG. 6 illustrates an interior cabin view of the cockpit area in an automotive vehicle, wherein a driver information center (DIC), an audio system, and a climate control system are conventionally situated separate from each other in the vehicle's instrument panel (dashboard).

FIG. 7 illustrates a frontal view of a second embodiment of an instrumentation module according to the present invention.

FIG. 8A illustrates the first part of an electrical circuit diagram that shows some of the various electronic systems included in the instrumentation module depicted in FIG. 7.

FIG. 8B illustrates the second part of the electrical circuit diagram depicted in FIG. 8A.

FIG. 9 illustrates a frontal view of a third embodiment of an instrumentation module according to the present invention.

FIG. 10A illustrates the first part of an electrical circuit diagram that shows some of the various electronic systems included in the instrumentation module depicted in FIG. 9.

FIG. 10B illustrates the second part of the electrical circuit diagram depicted in FIG. 10A.

FIG. 11 illustrates a frontal view of a fourth embodiment of an instrumentation module according to the present invention.

FIG. 12A illustrates the first part of an electrical circuit diagram that shows some of the various electronic systems included in the instrumentation module depicted in FIG. 11.

FIG. 12B illustrates the second part of the electrical circuit diagram depicted in FIG. 12A.

### DETAILED DESCRIPTION OF THE INVENTION

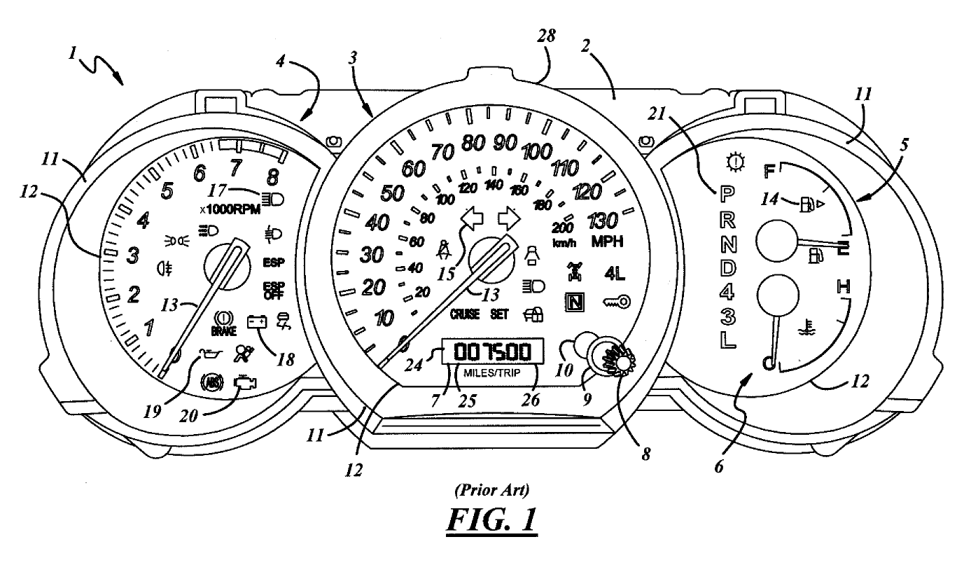

FIG. 1 illustrates a frontal view of a conventional gauge cluster 1 that is mounted in an instrument panel 2 of a modern automotive vehicle. As shown, the gauge cluster 1 includes a speedometer 3, a tachometer 4, a fuel-level gauge 5, and an engine coolant temperature gauge 6. The speedometer 3, in particular, includes an odometer 7 with a digital display 24. The digital display 24 exhibits either total mileage information 25 or trip mileage information 26 for the vehicle, as selectively controlled by a pushbutton 8. As illustrated in FIG. 1, the pushbutton 8 protrudes outward from the instrument panel 2, through a hole 10 defined through an appliqué 12, and ultimately out through a hole 9 defined through a transparent lens (or window) 11 of the speedometer 3. Such penetration through the lens 11, however, often undesirably facilitates the introduction of dust and dirt into the instrument panel's enclosure 28 via the lens hole 9. As a result, over time, dust and dirt can undesirably accumulate on the speedometer's viewable appliqué 12 and never be cleaned away. Consequently, the speedometer 3 and the overall instrument panel 2 may begin to appear dirty and unattractive.

To remedy such a problem, the present invention proposes an instrumentation assembly that eliminates such a protruding pushbutton from its gauge cluster while also retaining similar pushbutton control and functionality therein. In this way, therefore, mechanical penetration through a gauge cluster's lens will largely be obviated, thereby ensuring that the inside of the instrument panel's enclosure stays clean and attractive. For clarity, FIG. 1, also illustrates a rotatable pointing needle (of an analog gauge) 13.

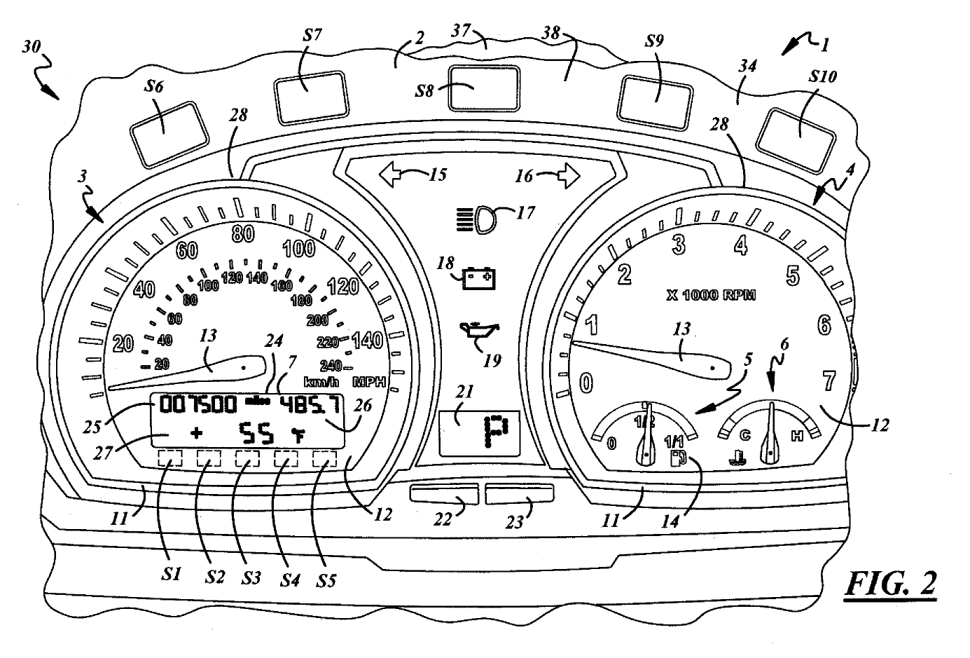

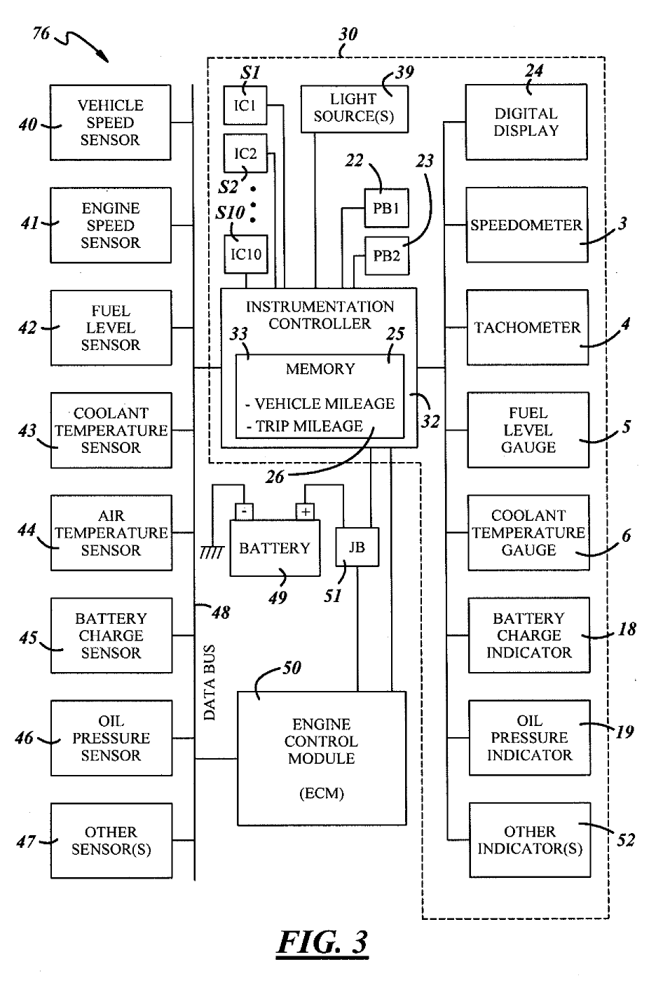

FIG. 2 illustrates a frontal view of one embodiment of an instrumentation assembly 30 according to the present invention. In addition thereto, FIG. 3 illustrates a block diagram of an automotive vehicle system 76 that includes the instrumentation assembly 30 depicted in FIG. 2. As shown in these figures, the instrumentation assembly 30 includes an electronic controller 32, an enclosure 28, at least one viewable gauge, a viewable display 24, and at least one proximity-sensing switch S. The controller 32 has a memory 33 for storing various types of information. The enclosure 28 has a designated front section and a designated rear section, wherein the front section includes substantially transparent material so as to define at least one window 11. Each gauge and the display 24 are electrically connected to the controller 32 and mounted within the enclosure 28 so as to substantially face the window(s) 11. Each switch S is electrically connected to the controller 32 and operable to sense the proximal presence of a mass, such as a human finger. In this configuration, the display 24 is operable to exhibit the memory's information or other information for viewing, and each switch S is activatable by a human finger to selectively control the exhibition of various types of information on the display 24. Furthermore, though the embodiment of the instrumentation assembly 30 shown in FIGS. 2 and 3 particularly includes ten proximity-sensing switches S1-S10, it is to be understood that an instrumentation assembly pursuant to the present invention may alternatively have fewer or more switches in other embodiments.

Moreover, in the embodiment shown in FIGS. 2 and 3, each of the proximity-sensing switches S1-S10 is a touch-sensor type switch such as, for example, a field-effect switch, an electric-field switch, a capacitive switch, an infrared switch, an acoustic switch, or an electromagnetic switch. In embodiments built to date, field-effect switches referred to as “TouchCells™,” which are manufactured by TouchSensor Technologies LLC of Wheaton, Ill., have been successfully incorporated in instrumentation assemblies pursuant to the present invention. During operation, the electrically charged electrodes of a TouchCell's integrated circuit (IC) can sense, and be activated by, the proximal encroachment or actual touch of an electrically conductive mass. Such an electrically conductive mass may include, for example, a human finger or a metallic stylus. Since actual touch of a TouchCell's electrodes is not necessary to activate a TouchCell, a TouchCell may therefore be activated by an encroaching conductive mass, even if the TouchCell and the mass are physically separated by an intervening dielectric structure, such as a thin layer of glass or plastic. Furthermore, though embodiments built to date have successfully incorporated such TouchCells, it is believed that other types of proximity-sensing switches produced by other manufacturers may alternatively be incorporated in instrumentation assemblies pursuant to the present invention as well.

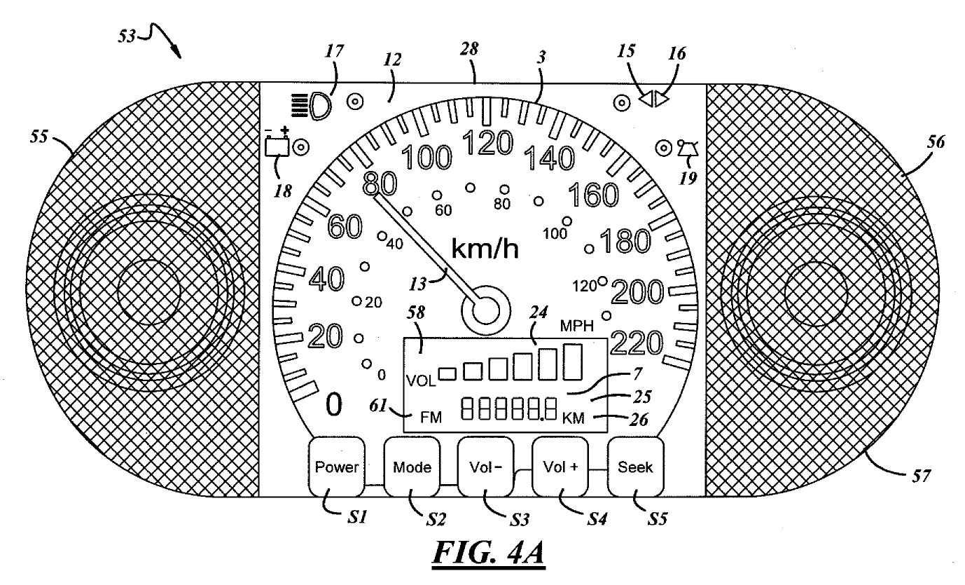

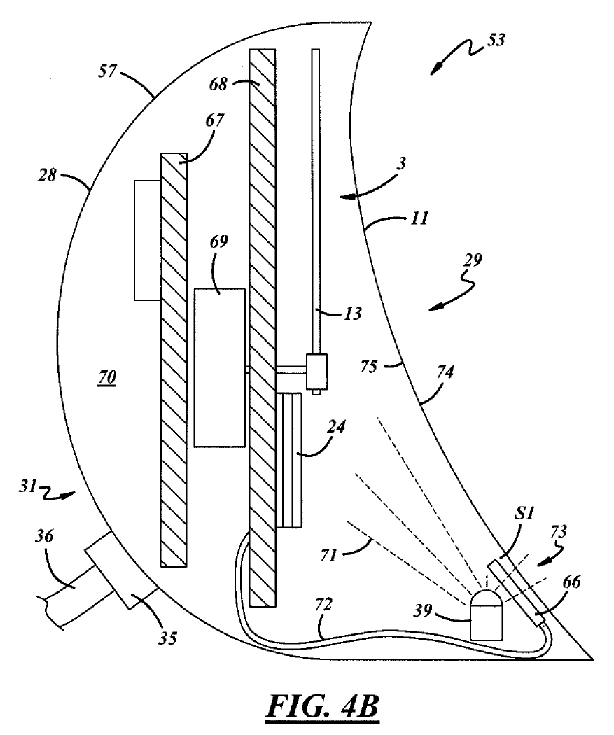

In general, a proximity-sensing switch may be situated in many various different locations in or about the enclosure of an instrumentation assembly pursuant to the present invention. In FIG. 2, the proximity-sensing switches S1-S5 are situated within the enclosure 28 of the speedometer 3, just behind the speedometer's window 11. Situated as such, each of the switches S1-S5 can be individually activated by a human fingertip that closely encroaches or touches a corresponding area on the outer surface 74 of the window 11. To assist a person in selecting and activating a desired switch, the outer surface 74 or inner surface 75 of the window 11 may be stenciled, painted, or back lit (see FIG. 4B) with switch or function-identifying words, markings, or icons. Also in FIG. 2, the proximity-sensing switches S6-S10 are alternatively situated just underneath the dielectric outer skin 38 of a brow area 34 on the dashboard 2. Situated as such, each of the switches S6-S10 can be individually activated by a human fingertip that closely encroaches or touches the outer surface of a corresponding skin area that covers a switch. To assist a person in selecting and activating a desired switch, the outer surface of the dashboard's skin 38 may be stenciled, painted, or stitched with switch or function-identifying words, markings, or icons. Furthermore, though the switches S1-S10 in FIG. 2 are largely situated in or about the enclosure 28 of the instrumentation assembly 30, such switches may alternatively be situated in other areas of a vehicle's cockpit. Such other areas may include, for example, a center stack console, a floor console, an overhead console, a door's trim, or even a steering wheel (handwheel).

Though the instrumentation assembly 30 is shown in FIGS. 2 and 3 as primarily including a speedometer 3, it is to be understood that an instrumentation assembly pursuant to the present invention may alternatively or additionally include other types of analog gauges as well. Such other analog gauges may include, for example, a tachometer 4, a fuel-level gauge 5, an engine coolant temperature gauge 6, and the like.

Furthermore, the viewable display 24 shown in FIG. 2 is generally a digital type display. As such, the display 24 may be, for example, a seven-segment display, a light-emitting diode (LED) display, a liquid-crystal display (LCD), a vacuum-fluorescent display (VFD), or similar others. The display 24 itself may exhibit many various different types of information. In general, the information exhibited by the display 24 is largely controlled by selective activation of the proximity-sensing switches S1-S10 or the mechanical pushbutton switches 22 and 23. Such information may include, for example, odometer total mileage information, odometer trip mileage information, air temperature information, clock time information, or still other information.

Moreover, in addition to the gauges, the display 24, and the proximity-sensing switches S1-S10, the instrumentation assembly 30 may further include one or more illuminable type indicators. Such indicators may include, for example, a left-turn indicator light 15, a right-turn indicator light 16, a high-beam indicator light 17, a battery-charge indicator light 18, an oil-pressure indicator light 19, a low-fuel indicator light 14, a check-engine indicator light 20, or others. In general, such illuminable type indicators may include light-emitting diodes (LEDs) or other conventional indicator light sources.

For clarity, FIG. 2 also illustrates: rotatable pointing needle (of an analog gauge) 13; a gear-position indicator (light(s)) 21; and an inner substrate (of the dashboard) 37. For clarity FIG. 3 also illustrates: a vehicle speed sensor 40; an engine speed sensor 41; a fuel level sensor 42; a coolant temperature sensor 43; an air temperature sensor 44; a battery charge sensor 45; an air pressure sensor 46; and other sensor(s) 47; a junction block (fuse box) 51; and other indicator(s) 52.

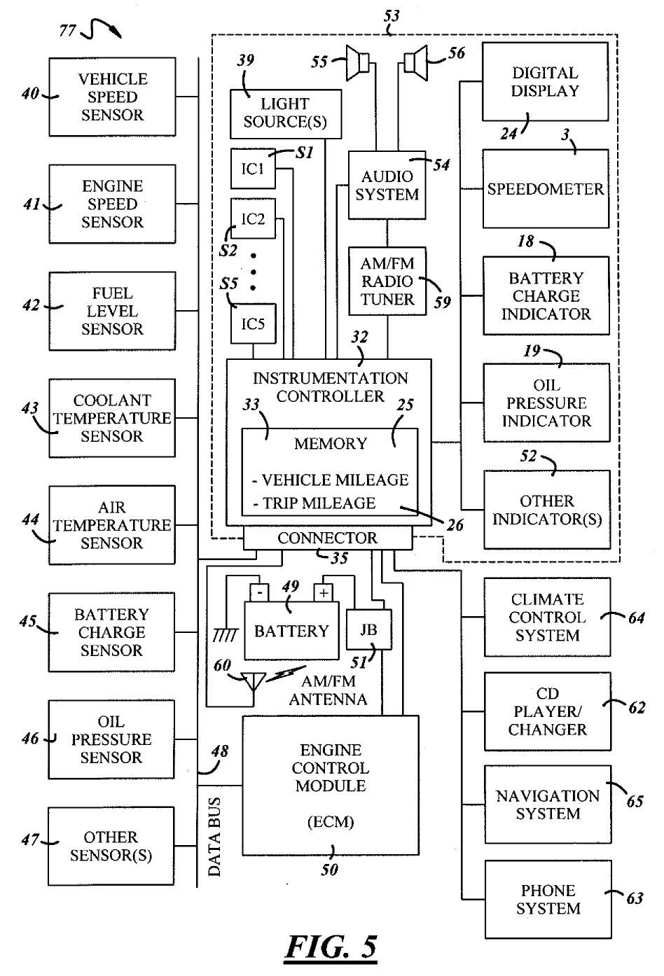

FIGS. 4A and 4B illustrate frontal and sectional side views of an embodiment of an instrumentation module 53 according to the present invention. In addition thereto, FIG. 5 illustrates a block diagram of an automotive vehicle system 77 that includes the instrumentation module 53 depicted in FIGS. 4A and 4B. As shown in these figures, the instrumentation module 53 is somewhat similar to the afore-described instrumentation assembly 30, except that the instrumentation module 53 is significantly more modular for purposes of in-vehicle installation and also includes an integrated audio system 54 with speakers 55 and 56.

As shown in FIGS. 4A and 4B, the overall enclosure 28 of the instrumentation module 53 has an outer periphery 57 that is largely rounded and a sectional profile that is substantially curvilinear. The instrumentation module 53 is shaped in this manner so as to facilitate easy installation of the module 53 into an automotive vehicle. As shown in FIGS. 4B and 5, the rear section 31 of the module's enclosure 28 has an electrical connector 35. In general, the connector 35 is electrically connected to the module's internal electronic controller 32 and is adapted for being electrically connected to an external wire harness 36. In this way, when the instrumentation module 53 is installed in a vehicle, the module's controller 32 is thereby electrically interfaced with the data bus 48, the engine control module (ECM) 50, and the battery 49 of the vehicle system 77 via the connector 35 and the harness 36. When the controller 32 is interfaced and connected in such a configuration, various sensor data, electrical control signals, and battery power can thus be electrically communicated to the controller 32, the display 24, the gauge(s), and the indicator(s) in the module 53.

Furthermore, as illustrated in FIGS. 4A and 5, the audio system 54 is electrically connected to the instrumentation module's controller 32. The left and right speakers 55 and 56, in turn, are electrically connected to the audio system 54 and are also mounted opposite each other at the periphery 57 of the module's enclosure 28. In this configuration, the proximity-sensing switches S1-S4 can be finger activated to selectively control operation of the audio system 54 with speakers 55 and 56. The switches S3 and S4, in particular, can be utilized to control and set the volume level of the audio system 54. To farther help facilitate selective control of the audio system's volume, the module's display 24 is operable to exhibit volume control information 58.

As also illustrated in FIGS. 4A and 5, the instrumentation module 53 also includes an integrated AM/FM radio tuner 59. The radio tuner 59 is mounted within the module's enclosure 28 and is electrically connected to both the controller 32 and the audio system 54. The radio tuner 59 is adapted for being electrically connected, via the connector 35, to an external AM/FM radio antenna 60, which is mounted aboard the vehicle. In this configuration, all proximity-sensing switches S1-S5 can be selectively activated to control operation of the AM/FM radio tuner 59 together with the audio system 54. The switch S2 (i.e., the “Mode” switch), in particular, can be utilized in conjunction with the radio tuner 59 to select either an AM broadcast or an FM broadcast. After selecting a desired radio broadcast type with switch S2, the switch S5 (the “Seek” switch) can then be selectively held or quickly tapped so as to tune into a particular radio station broadcast along a broadcast frequency spectrum. To help in this selection process, the module's display 24 is operable to exhibit radio station tuning control information 61 for viewing. Once a radio station broadcast is ultimately selected with switch S5, the audio system 54 and speakers 55 and 56 operate together to audibly play the radio station broadcast, which is electrically communicated from the radio antenna 60 via the connector 35.

Moreover, as indicated in FIGS. 4A and 5, the module's controller 32 is adapted for being electrically connected, via connector 35, to an external compact disc (CD) player/changer 62, which is carried aboard the vehicle. When the controller 32 is connected as such, the switch S2 can be activated and utilized to obtain auxiliary (AUX) mode control over the CD player/changer 62. Once control is obtained, the switch S5 can then be utilized to seek and select particular CDs and songs for play on the audio system 54, and switches S3 and S4 can be utilized to set play volume. The module's display 24 is operable to exhibit CD player/changer control information for viewing.

Furthermore, as also indicated in FIGS. 4A and 5, the module's controller 32 is adapted for being electrically connected, via connector 35, to an external phone system 63, which is carried aboard the vehicle. When the controller 32 is connected as such, the switch S2 can be activated and utilized to obtain auxiliary (AUX) mode control over the phone system 63. Once such control is obtained, the switch S5 can then be utilized to seek and dial pre-programmed phone numbers that are stored in the phone system's memory or alternatively dial other phone numbers. During such operation of the phone system 63, the module's display 24 is able to exhibit phone number information and/or caller identification (ID) information for viewing. The audio system 54, in turn, is operable to selectively play each phone conversation over the speakers 55 and 56 to facilitate hands-free operation of the phone system 63.

As farther indicated in FIGS. 4A and 5, the module's controller 32 is also adapted for being electrically connected, via connector 35, to an external climate control system 64, which is carried aboard the vehicle. When the controller 32 is connected as such, the switch S2 can be activated and utilized to obtain auxiliary (AUX) mode control over the climate control system 64. Once such control is obtained, the switches S3 and S4 can then be utilized to adjust blower fan (i.e., motor) speed of the climate control system 64. The switch S5, in turn, can be utilized to selectively activate the air-conditioning (AC) system, the heating system, or the defrost system of the climate control system 64. During such operation of the climate control system 64, the display 24 is operable to exhibit climate condition information 27 (for example, air temperature) and also climate control information for viewing.

Moreover, as also indicated in FIGS. 4A and 5, the module's controller 32 is also adapted for being electrically connected, via connector 35, to an external navigation system 65, which is mounted aboard the vehicle. When the controller 32 is connected as such, the switch S2 can be activated and utilized to obtain auxiliary (AUX) mode control over the navigation system 65. Once such control is obtained, the switches S3-S5 can then be utilized to operate the navigation system 65. During such operation of the navigation system 65, the module's display 24 is able to exhibit navigation information, such as vehicle heading or travel directions, as well as navigation system control information.

Furthermore, as shown in FIGS. 4B and 5, the instrumentation module 53 further includes at least one light source 39. The light source 39 is electrically connected to the instrumentation module's controller 32. The light source 39 is also mounted within the module's enclosure 28, generally between the display 24 and the switches S1-S5. Situated as such, the light source 39 generally serves to illuminate the front of both the speedometer 3 and the display 24. In addition, the light source 39 also serves as backlighting for the switches S1-S5, thereby making the switches S1-S5 easier to see and identify from outside the module's window 11. To further help a person see and identify the switches S1-S5, either the outer surface 74 or the inner surface 75 of the enclosure's window 11 may optionally be painted or stenciled with switch or function-identifying words, markings, or icons that are correspondingly situated over the switches' respective ICs. As an alternative, the bottom of the enclosure's window 11 may instead be treated so as render the bottom of the window 11 more translucent. In this way, the bottom of the window 11 may alternatively be illuminated by a light projector from within the enclosure 28 that instead projects images of switch or function-identifying words, markings, or icons onto the window 11.

In summary, an instrumentation assembly or module pursuant to the present invention generally includes one or more proximity-sensing switches situated in various locations about its enclosure. For example, a switch may be situated within an enclosure and just behind the enclosure's thin window, or a switch may alternatively be situated just underneath a thin, outer skin layer of the dashboard. In this way, therefore, the switch can be activated without requiring mechanical penetration through the enclosure's window. As a result, dust and dirt is largely prevented from entering the enclosure and making it and its contents appear dirty and unattractive. Furthermore, though more conventional mechanical switches, such as pushbutton or rotary type switches, may also be included in an instrumentation assembly or module pursuant to the present invention, care should be exercised so that their inclusion does not inadvertently facilitate the introduction of dust and dirt into an instrumentation enclosure.

For clarity, FIGS. 4A & 4B illustrate a rotatable pointing needle (of an analog gauge) 13. For clarity, FIG. 4B further illustrates: a front section (of enclosure) 4B; and integrated circuit (IC) (of a proximity-sensing switch) 66; a printed circuit board (PCB) (associated with audio system and speakers) 67; a printed circuit board (PCB) (associated with controller, gauge, and display) 68; an electric motor (for rotating needle of gauge) 69; a hollow (of enclosure) 70; light rays (emanating from light source) 71; an electrical lead line (between controller and IC of proximity-sensing switch) 72; and a proximity-sensing zone, actuation zone, or touch zone (of switch) 73. For further clarity, FIG. 5 also further illustrates: a vehicle speed sensor 40; an engine speed sensor 41; a fuel level sensor 42; a coolant temperature sensor 43; an air temperature sensor 44; a battery charge sensor 45; an air pressure sensor 46; and other sensor(s) 47; a junction block (fuse box) 51; and other indicator(s) 52.

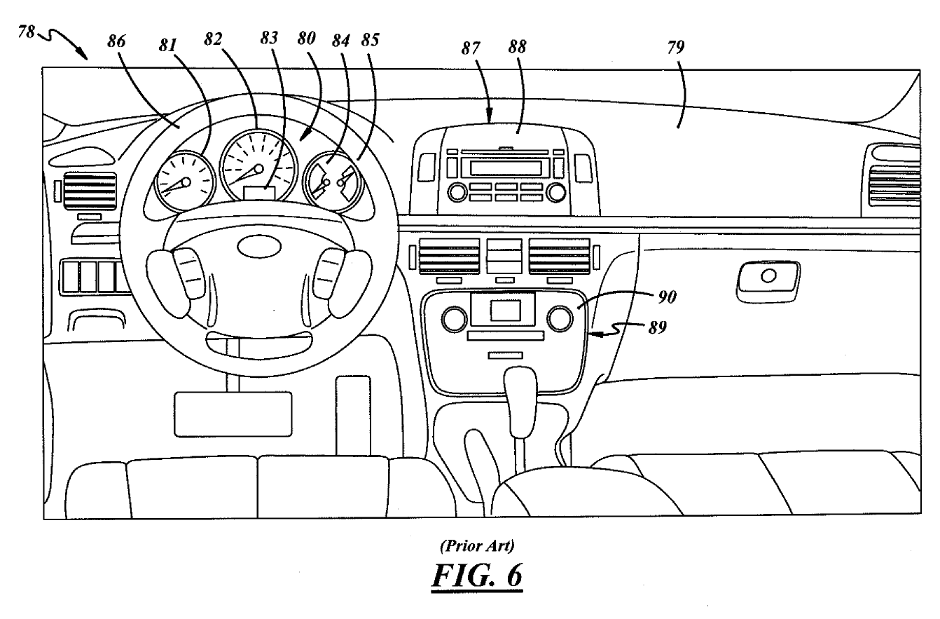

FIG. 6 illustrates an interior cabin view of a cockpit area 78 in an automotive vehicle. As shown, an instrument panel 79 in the cockpit area 78 includes a driver information center (DIC) 80, an audio system 87, and a climate control system 89, which are all situated separate from each other per convention. Such separation between these three systems, however, is generally undesirable, for such requires a vehicle driver to avert his eyes or reach his hands to three separate locations in order to successfully interact with these systems. Furthermore, such separation of these systems also tends to render a conventional instrument panel both structurally and electrically complex, and hence costly as well. In view of such, there is a present need in the art for an instrument panel assembly that successfully combines and integrates these three systems into a more unitary system or structure. In this way, therefore, driver-to-panel interaction is improved, panel space is conserved, panel complexity is minimized, and panel cost is reduced.

For clarity, FIG. 6, further illustrates; a tachometer (an analog type gauge) 81; a speedometer (an analog type gauge) 82; a viewable digital display 83; a fuel-level gauge (an analog type gauge) 84; an engine coolant temperature gauge (an analog type gauge) 85; a steering wheel (handwheel) 86; a head unit or console (of audio system) 88; and a head unit or console (of climate control system) 90.

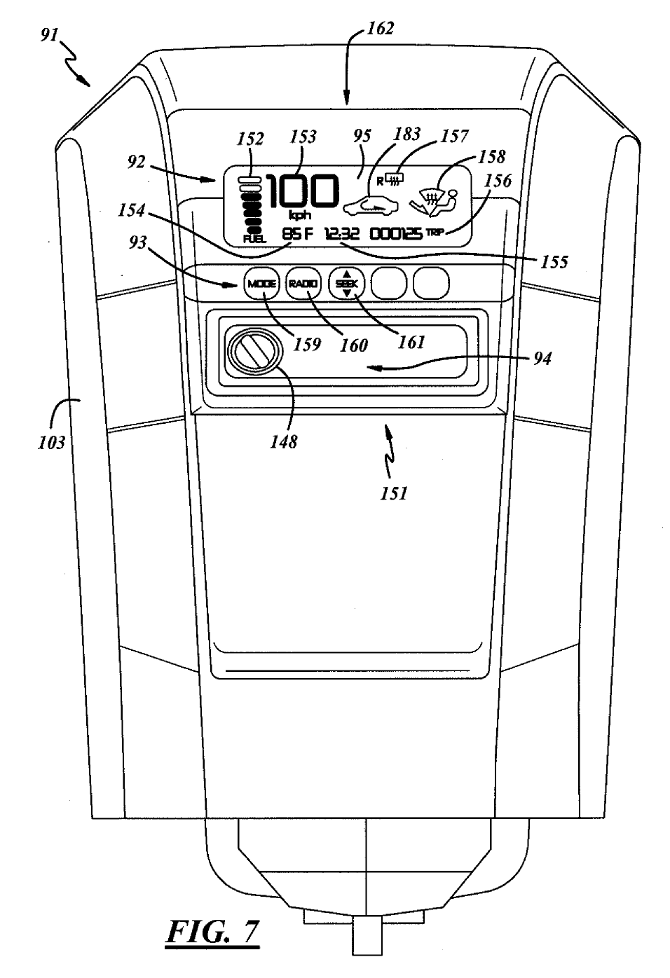

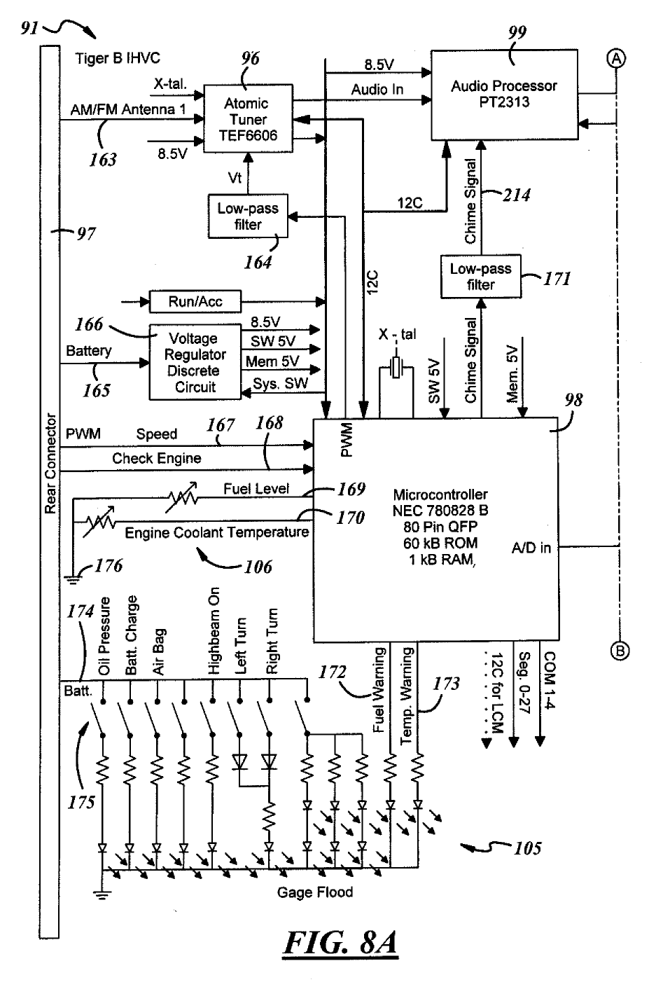

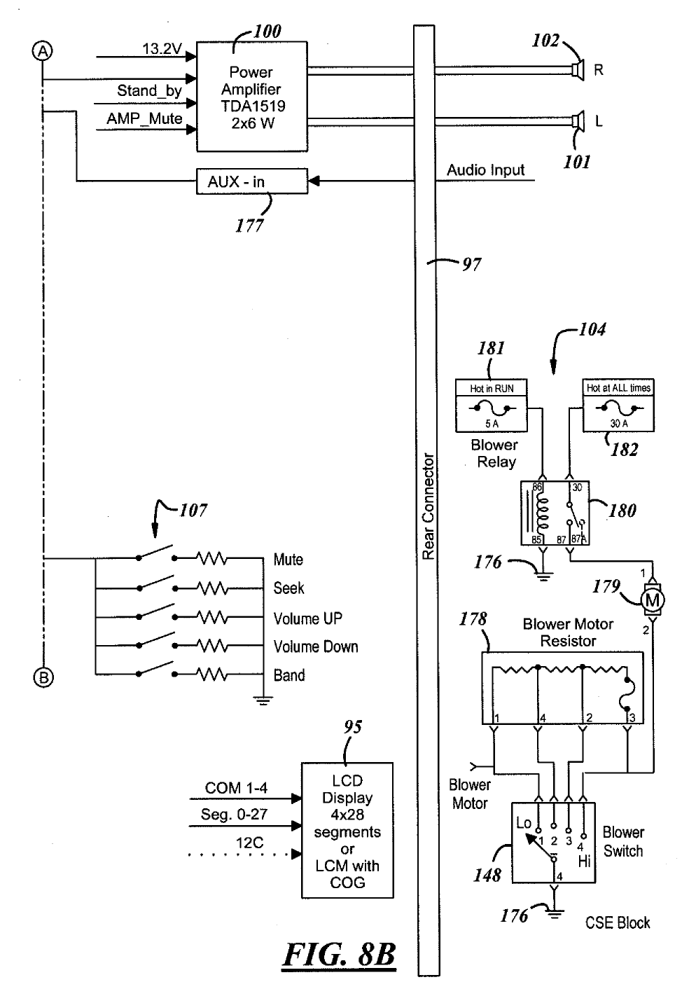

To successfully combine a driver information center (DIC), an audio system, and a climate control system together into a more unitary system or structure, the present invention herein provides another embodiment of an instrumentation module. In particular, FIG. 7 illustrates a frontal view of a second embodiment of an instrumentation module 91 according to the present invention. FIGS. 8A and 8B illustrate an electrical circuit diagram of the instrumentation module 91 depicted in FIG. 7. As shown, the instrumentation module 91 includes an enclosure 103, an electronic controller 98, a viewable display 95, a driver information center 92, an audio system 93, a climate control system 94, and a plurality of switches 151. The enclosure 103 has a designated front section and a designated rear section, wherein the rear section has an electrical connector 97. The electronic controller 98 is mounted within the enclosure 103 and is electrically connected to the connector 97. The controller 98 also has both random-access memory (RAM) and read-only memory (ROM) for therein storing information. The display 95 is mounted in the front section of the enclosure 103 and is electrically connected to the controller 98. The driver information center 92 is mounted in the enclosure 103 and is electrically connected to one or more of the connector 97, the controller 98, and the display 95. Both the audio system 93 and the climate control system 94 are mounted within the enclosure 103 and are each electrically connected to one or more of the connector 97, the controller 98, the display 95, and the driver information center 92. Lastly, the switches 151 are mounted in the front section of the enclosure 103 and are electrically connected to one or more of the controller 98, the display 95, the driver information center 92, the audio system 93, and the climate control system 94. In this configuration, the switches 151 are activatable by human fingers for thereby selectively controlling the display 95, the driver information center 92, the audio system 93, and the climate control system 94.

For clarity, FIG. 7 further illustrates: a fan-speed blower control (including a rotary switch) 148; a fuel-level indicator or gauge 152; a speedometer 153; a climate condition information (for example, air temperature) 154; a digital clock 155; an odometer (shows total mileage and/or trip mileage for a vehicle) 156; a rear-window air-flow indicator (light) 157; a front-window and floor air-flow indicator (light) 158; a mode-control button or switch (of audio system) 159; radio on/off control button or switch (of audio system) 160; station-seek control button or switch (of audio system) 161; front section of enclosure (with common control panel) 162; and a cabin air-intake open/closed indicator (light) 183.

For clarity, FIG. 8A further illustrates: an AM/FM radio tuner 96; an audio processor (of audio system) 99; various indicator lights (illustrated as LEDs) (of driver information center) 105; various information inputs (for driver information center) 106; an AM/FM radio broadcast input signal (from antenna aboard vehicle) 163; a low-pass filter 164; a power voltage signal (from vehicle battery) 165; a voltage-level regulator circuit 166; a PWM voltage signal for indicating vehicle speed (from speed sensor) 167; a check-engine warning signal (from, for example, a voltage-level sensor) 168; a fuel-level indication signal (from fuel-level sensor) 169; coolant-temperature indication signal (from thermistor) 170; a low-pass filter 171; low-fuel warning signal (to driver information center) 172; a coolant-temperature warning signal (to driver information center) 173; a power voltage signal (from vehicle battery) 174; switches (for enabling illumination of indicator lights) 175; an electrical ground (for example, vehicle chassis) 176; a chime signal (of audio system 214; and a crystal (transducer) 227.

For clarity, FIG. 8B further illustrates: a power amplifier (of audio system) 100; an external left speaker 101; an external right speaker 102; a fan blower system (of climate control system) 104; various control switches (of audio system and radio tuner) 107; fan-speed blower control (including a rotary switch) 148; an electrical ground (for example, vehicle chassis) 176; an auxiliary-input port or connector (for receiving external audio input) 177; a resistor network (for blower motor) 178; blower motor (for rotating fan) 179; relay (of fan blower system) 180; and fuses 181, 182.

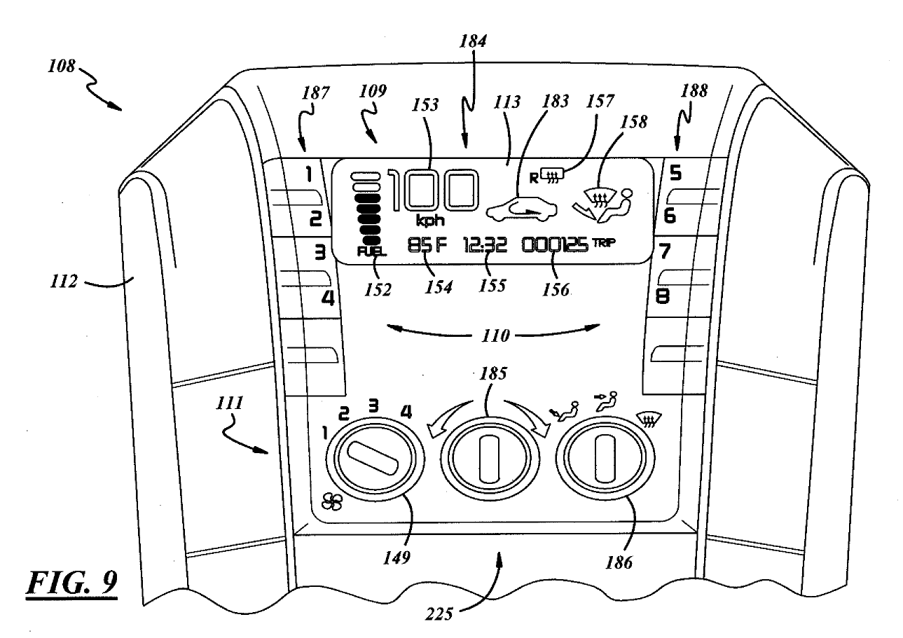

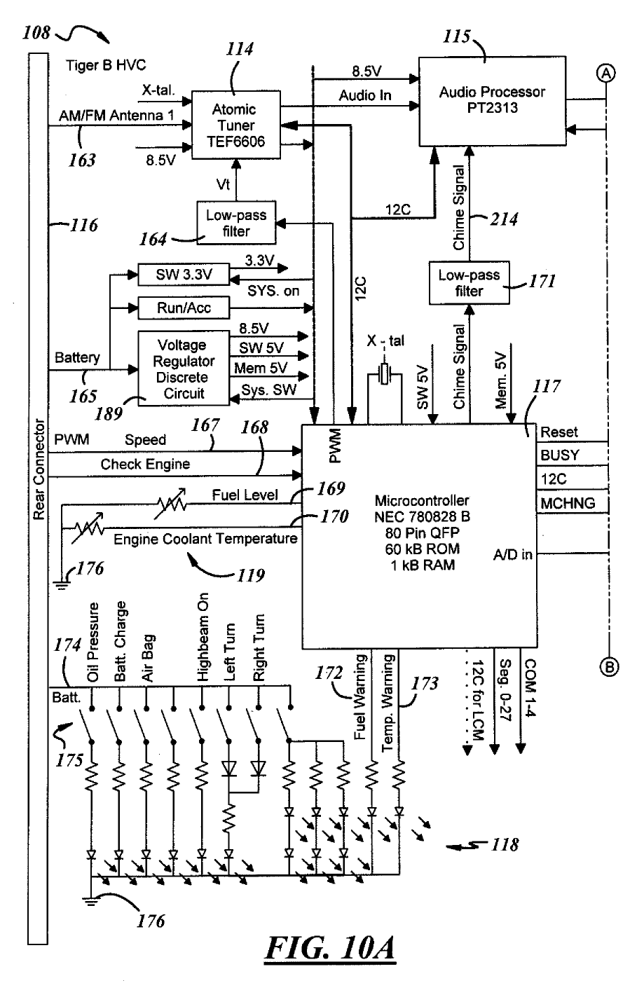

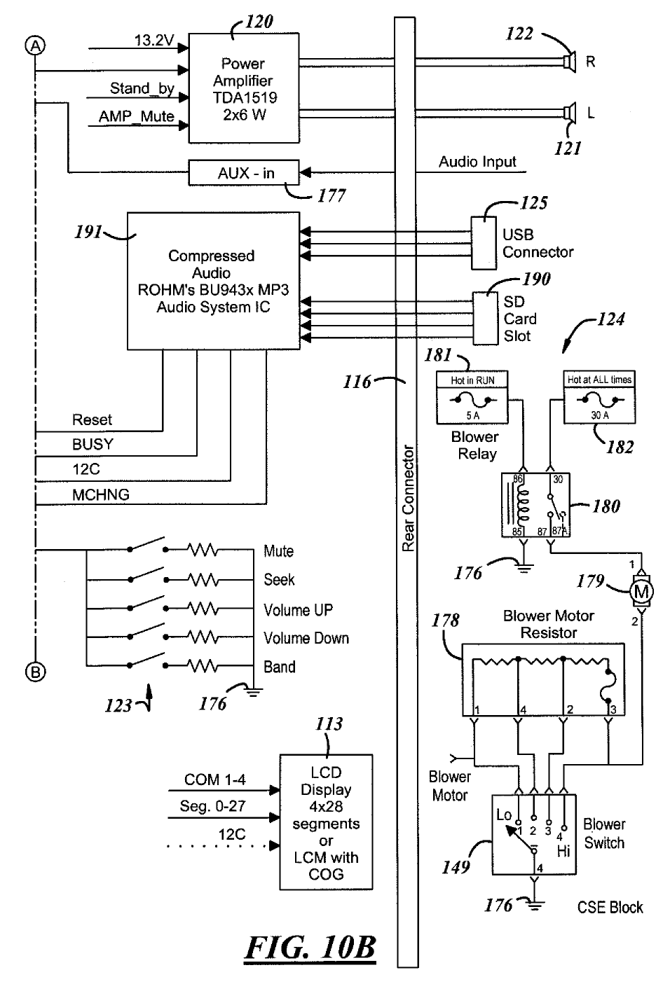

In addition to the above, FIG. 9 illustrates a frontal view of a third embodiment of an instrumentation module 108 according to the present invention. FIGS. 10A and 10B illustrate an electrical circuit diagram of the instrumentation module OS depicted in FIG. 9. As shown in FIGS. 9-10B, the third-embodiment instrumentation module 108 additionally includes a separate cabin-temperature control 185 and a separate cabin air-flow control 186 for its climate control system 111.

For clarity, FIG. 9 further illustrates: a driver information center (DIC) 109; an audio system (including audio processor and power amplifier) 110; an enclosure (of instrumentation module) 112; viewable display 113; fan-speed blower control (including a rotary switch) 149; a fuel-level indicator or gauge 152; a speedometer 153; a climate condition information (for example, air temperature) 154; a digital clock 155; an odometer (shows total mileage and/or trip mileage for a vehicle) 156; a rear-window air-flow indicator (light) 157; a front-window and floor air-flow indicator (light) 158; a cabin air-intake open/closed indicator (light) 183; a front section of enclosure (with common control panel) 184; a first bank of control buttons or switches (of audio system) 187; a second bank of control buttons or switches (of audio system) 188; and a plurality of various switches (for example, pushbutton, rotary, or touch-sensor) 225.

For clarity, FIG. 10A further illustrates: an AM/FM radio tuner 114; an audio processor (of audio system) 115; an electrical connector (on rear section of enclosure) 116; an electronic controller (with memory) 117; various indicator lights (LEDs) (of driver information center) 118; various information inputs (for driver information center) 119; an AM/FM radio broadcast input signal (from antenna aboard vehicle) 163; a low-pass filter 164; a power voltage signal (from vehicle battery) 165; a PWM voltage signal for indicating vehicle speed (from speed sensor) 167; a check-engine warning signal (from, for example, a voltage-level sensor) 168; a fuel-level indication signal (from fuel-level sensor) 169; coolant-temperature indication signal (from thermistor) 170; a low-pass filter 171; low-fuel warning signal (to driver information center) 172; a coolant-temperature warning signal (to driver information center) 173; a power voltage signal (from vehicle battery) 174; switches (for enabling illumination of indicator lights) 175; an electrical ground (for example, vehicle chassis) 176; a voltage-level regulator circuit 189; a chime signal 214; and a crystal (transducer) 227.

For clarity, FIG. 10B further illustrates: a viewable display 113; an electrical connector (on rear section of enclosure) 116; a power amplifier (of audio system) 120; an external left speaker 121; external right speaker 122; various control switches (of audio system and radio tuner) 123; fan blower system (of climate control system) 124; universal serial bus (USB) connector 125; a fan-speed blower control (including rotary switch) 149; an electrical ground (for example, vehicle chassis 176; an auxiliary-input port or connector (for receiving external audio input) 177; a resistor network (for blower motor) 178; blower motor (for rotating fan) 179; relay (of fan blower system) 180; fuses 181, 182; secure digital (SD) card slot 190; and a compressed-audio integrated circuit (of audio system) 191.

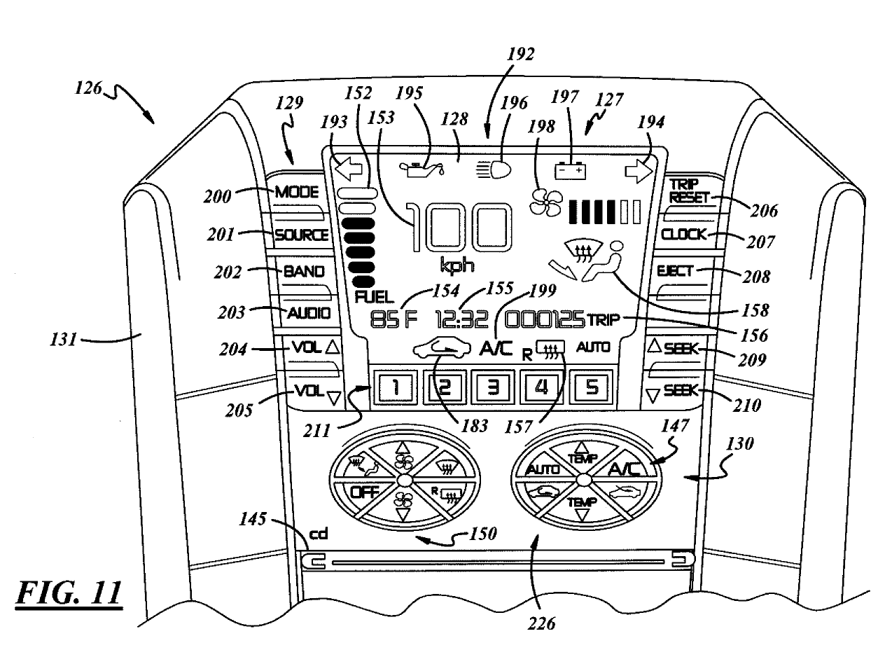

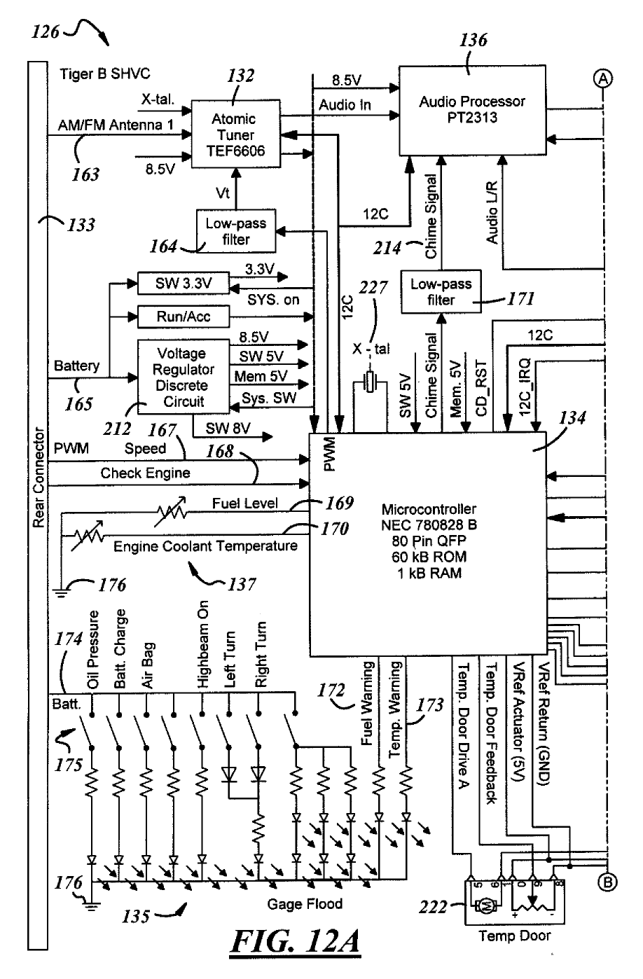

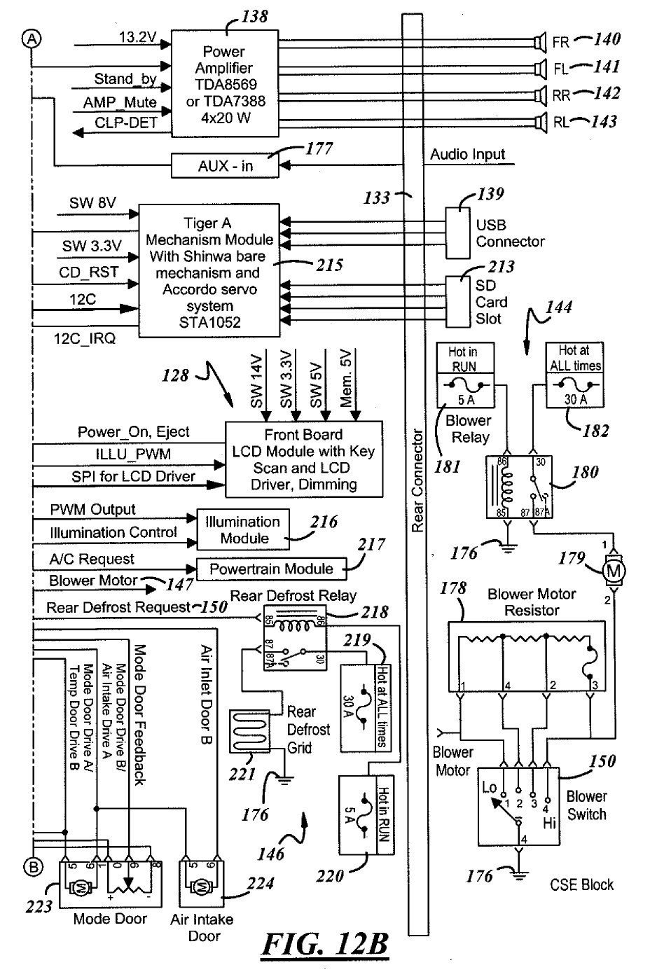

Furthermore, FIG. 11 illustrates a frontal view of a fourth embodiment of an instrumentation module 126 according to the present invention. FIGS. 12A and 12B illustrate an electrical circuit diagram of the instrumentation module 126 depicted in FIG. 11. As shown in FIGS. 11-12B, the fourth-embodiment instrumentation module 126 additionally includes both a compact disc (CD) player 145 and a rear-window defrost system 146 in contrast to the second-embodiment module 91 and the third-embodiment module 108.

For clarity, FIG. 11 illustrates: driver information center (DIC) 127; viewable display 128; audio system (including audio processor and power amplifier) 129; climate control system 130; enclosure (of instrumentation module) 131; an air-conditioning (A/C) controls cluster (of climate control system) 147; a fan blower controls cluster (of climate control system) 150; a fuel-level indicator or gauge 152; a speedometer 153; a climate condition information (for example, air temperature) 154; a digital clock 155; an odometer (shows total mileage and/or trip mileage for a vehicle) 156; a rear-window air-flow indicator (light) 157; a front-window and floor air-flow indicator (light) 158; a cabin air-intake open/closed indicator (light) 183; front section of enclosure (with common control panel) 192; vehicle left-turn indicator (light) 193; vehicle right-turn indicator (light) 194; oil-pressure indicator (light) 195; headlights high-beam indicator (light) 196; battery-charge indicator (light) 197; blower fan-speed indicator (light) 198; air-conditioning (A/C) on/off indicator (light) 199; mode-control button or switch (of audio system) 200; source-select button or switch (of audio system) 201; radio band-select button or switch (of audio system) 202; audio-select button or switch (of audio system) 203 ; volume-increase button or switch (of audio system) 204; volume-decrease button or switch (of audio system) 205; trip-mileage reset button or switch (of odometer) 206; time-reset button or switch (of digital clock) 207; disc-eject button or switch (of compact-disc player) 208; seek-forward control button or switch (of audio system) 209; seek-backward control button or switch (of audio system) 210; bank of preset buttons or switches (of audio system) 211; and a plurality of various switches (for example, pushbutton, rotary, or touch-sensor) 226.

For clarity, FIG. 12A further illustrates: AM/FM radio tuner 132; electrical connector (on rear section of enclosure) 133; electronic controller (with memory) 134; various indicator lights (LEDs) (of driver information center) 135; audio processor (of audio system) 136; various information inputs (for driver information center) 137; an AM/FM radio broadcast input signal (from antenna aboard vehicle) 163; a low-pass filter 164; a power voltage signal (from vehicle battery) 165; a voltage-level regulator circuit 166; a PWM voltage signal for indicating vehicle speed (from speed sensor) 167; a check-engine warning signal (from, for example, a voltage-level sensor) 168; a fuel-level indication signal (from fuel-level sensor) 169; coolant-temperature indication signal (from thermistor) 170; a low-pass filter 171; low-fuel warning signal (to driver information center) 172; a coolant-temperature warning signal (to driver information center) 173; a power voltage signal (from vehicle battery) 174; switches (for enabling illumination of indicator lights) 175; an electrical ground (for example, vehicle chassis) 176; a chime signal (of audio system 214; a voltage-level regulator circuit 212; a motorized temp door 222; and a crystal (transducer) 227.

For clarity, FIG. 12B further illustrates: a viewable display 128; an electrical connector (on rear section of enclosure) 133; power amplifier (of audio system) 138; universal serial bus (USB) connector 139; external front-right speaker 140; external front-left speaker 141; external rear-right speaker 142; external rear-left speaker 143; fan blower system (of climate control system) 144; an air-conditioning (A/C) controls cluster (of climate control system) 147; a fan blower controls cluster (of climate control system) 150; an electrical ground (for example, vehicle chassis 176; an auxiliary-input port or connector (for receiving external audio input) 177; a resistor network (for blower motor) 178; blower motor (for rotating fan) 179; relay (of fan blower system) 180; fuses 181, 182; secure digital (SD) card slot 213; a mechanism module 215; an illumination module 216; powertrain module 217; relay (of rear-window defrost system) 218; fuse 219; fuse 220; defrost grid (for rear window of vehicle) 221; motorized mode door 223; and a motorized air-intake door 224.

In general, each of the instrumentation modules 91, 108, and 126 is more unitary and modular than conventional instrumentation assemblies and is thus more easily installable in a vehicle. To achieve such modularity, each of the instrumentation modules 91, 108, and 126 is generally configured so as to simply include a single mechanical enclosure, a single electronic controller or a largely centralized controller system, a single printed circuit board (PCB) or printed wiring board (PWB), a single viewable display, a single version of operating firmware, and a common control panel with multiple buttons, knobs, and/or switches substantially grouped together and functionally organized thereon. Configured as such, when one of these instrumentation modules is installed aboard a vehicle, the module renders the instrument panel or dashboard area of the vehicle more highly integrated. As a result, driver-to-panel interaction is improved, panel space is conserved, panel complexity is minimized, and panel cost is reduced.

While the present invention has been described in what are presently considered to be its most practical and preferred embodiments or implementations, it is to be understood that the invention is not to be limited to the particular embodiments disclosed hereinabove. On the contrary, the present invention is intended to cover various modifications and equivalent arrangements included within the spirit and scope of the claims appended hereinbelow, which scope is to be accorded the broadest interpretation so as to encompass all such modifications and equivalent structures as are permitted under the law.

What is claimed is:

1. An instrumentation module for installation in a dashboard of a vehicle, said instrumentation module comprising:
an enclosure having a designated front section and a designated rear section, said rear section having an electrical connector;
an electronic controller mounted within said enclosure, electrically connected to said connector, and having a memory for storing information;
a viewable display mounted in said front section of said enclosure and electrically connected to said controller;
a driver information center (DIC) mounted within said enclosure and electrically connected to at least one of said connector, said controller, and said display;
an audio system mounted within said enclosure and electrically connected to at least one of said connector, said controller, said display, and said driver information center;
a climate control system mounted within said enclosure and electrically connected to at least one of said connector, said controller, said display, and said driver information center; and
a plurality of switches mounted in said front section of said enclosure and electrically connected to at least one of said controller, said display, said driver information center, said audio system, and said climate control system;
wherein each of said switches is activatable by a human finger for thereby selectively controlling at least one of said display, said driver information center, said audio system, and said climate control system.

2. An instrumentation module according to claim 1, wherein said electrical connector is adapted for being electrically connected to an external wire harness.

3. An instrumentation module according to claim 1, wherein said memory includes a read-only memory (ROM).

4. An instrumentation module according to claim 1, wherein said memory includes a random-access memory (RAM).

5. An instrumentation module according to claim 1, wherein said display is a liquid-crystal display (LCD).

6. An instrumentation module according to claim 1, wherein said display is a vacuum-fluorescent display (VFD).

7. An instrumentation module according to claim 1, wherein said audio system includes an audio processor and a power amplifier.

8. An instrumentation module according to claim 1, wherein said instrumentation module further comprises an AM/FM radio tuner that is mounted within said enclosure and electrically connected to at least one of said connector, said controller, said display, said driver information center, and said audio system.

9. An instrumentation module according to claim 1, wherein said instrumentation module further comprises a compact-disc (CD) player that is mounted within said enclosure and electrically connected to at least one of said connector, said controller, said display, said driver information center, and said audio system.

10. An instrumentation module according to claim 1, wherein said climate control system includes blower controls.

11. An instrumentation module according to claim 1, wherein said climate control system includes air-conditioning (A/C) system controls.

12. An instrumentation module according to claim 1, wherein at least one of said switches is a touch-sensor type switch selected from the group consisting of a field-effect switch, an electric-field switch, a capacitive switch, an infrared switch, an acoustic switch, and an electromagnetic switch.

13. An instrumentation module according to claim 1, wherein at least one of said switches is a mechanical pushbutton type switch.

14. An instrumentation module according to claim 1, wherein at least one of said switches is a mechanical rotary type switch.

15. An instrumentation module for installation in a dashboard of a vehicle, said instrumentation module comprising:
an enclosure having a designated front section and a designated rear section, said rear section having an electrical connector;
an electronic controller mounted within said enclosure, electrically connected to said connector, and having a memory for storing information;
a viewable display mounted in said front section of said enclosure and electrically connected to said controller;
a driver information center (DIC) mounted within said enclosure and electrically connected to at least one of said connector, said controller, and said display;
an audio system mounted within said enclosure and electrically connected to at least one of said connector, said controller, said display, and said driver information center; and
a plurality of switches mounted in said front section of said enclosure and electrically connected to at least one of said controller, said display, said driver information center, and said audio system;
wherein each of said switches is activatable by a human finger for thereby selectively controlling at least one of said display, said driver information center, and said audio system.

16. An instrumentation module according to claim 15, wherein said audio system includes an audio processor and a power amplifier.

17. An instrumentation module according to claim 15, wherein said instrumentation module further comprises an AM/FM radio tuner that is mounted within said enclosure and electrically connected to at least one of said connector, said controller, said display, said driver information center, and said audio system.

18. An instrumentation module for installation in a dashboard of a vehicle, said instrumentation module comprising:
an enclosure having a designated front section and a designated rear section, said rear section having an electrical connector;
an electronic controller mounted within said enclosure, electrically connected to said connector, and having a memory for storing information;
a viewable display mounted in said front section of said enclosure and electrically connected to said controller;
a driver information center (DIC) mounted within said enclosure and electrically connected to at least one of said connector, said controller, and said display;
a climate control system mounted within said enclosure and electrically connected to at least one of said connector, said controller, said display, and said driver information center; and
a plurality of switches mounted in said front section of said enclosure and electrically connected to at least one of said controller, said display, said driver information center, and said climate control system;
wherein each of said switches is activatable by a human finger for thereby selectively controlling at least one of said display, said driver information center, and said climate control system.

19. An instrumentation module according to claim 18, wherein said climate control system includes blower controls.

20. An instrumentation module according to claim 18, wherein said climate control system includes air-conditioning (A/C) system controls.
